(19) United States
(12) Patent Application Publication
(10) Pub. No.: US 2016/0253398 A1
(43) Pub. Date: Sep. 1, 2016

(54) REPLICATING METADATA ASSOCIATED WITH A FILE

(71) Applicant: HEWLETT PACKARD ENTERPRISE DEVELOPMENT LP, Houston, TX (US)

(72) Inventors: Sivashanmugam Jothivelavan, Bangalore Karnataka (IN); Kannan Rajkumar, Bangalore Karnataka (IN); Kannan K. Ramesh, Bangalore Karnataka (IN); Roy Annmary, Bangalore Karnataka (IN); Pendyala Jaipal, Bangalore Karnataka (IN); Hamilton De Freitas Coutinho, Colorado Springs, CO (US); Guillherme De Campos Magalhaes, Porto Alegre (BR); Marcelo Bandeira Condotta, Andover, MA (US); Kimberly Keeton, San Francisco, CA (US); Charles B. Morrey, III, Palo Alto, CA (US); Michael J. Spitzer, Portland, OR (US)

(21) Appl. No.: 15/032,825

(22) PCT Filed: Dec. 6, 2013
(86) PCT No.: PCT/US2013/073591

§ 371 Date: Apr. 28, 2016

(51) Int. Cl. G06F 17/30

(52) U.S. Cl. CPC G06F 17/30575; G06F 17/30917; G06F 17/30174

(57) ABSTRACT

The present disclosure is generally related to replicating metadata. A method includes accessing a first file with a first unique identifier at a source location in a storage device, wherein metadata corresponding to the first file is stored in a first database with the first unique identifier. The method includes replicating the first file to produce a second file at a target location, wherein the second file has a second unique identifier. The method includes replicating the metadata and the first unique identifier to a second database. The method includes mapping the second unique identifier to the first unique identifier in the second database.

### BACKGROUND

Metadata for a file stored in a file system contains information describing the data contained in the file. The metadata may contain the file's unique identifier, among other attributes associated with the file. If the file is replicated to a different file system, the metadata may be replicated as well.

### BRIEF DESCRIPTION OF THE DRAWINGS

Certain examples are described in the following detailed description and in reference to the drawings, in which:

FIG. 1 is a block diagram of a computing system configured for replicating metadata, in accordance with examples of the present disclosure;

FIG. 2 is a block diagram illustrating metadata replication from a source file system to a target file system;

FIG. 3 is a process flow diagram of a method for replicating metadata, in accordance with examples of the present disclosure; and

FIG. 4 is a block diagram of a tangible, non-transitory computer-readable medium containing instructions configured to direct a processor to replicate metadata, in accordance with examples of the present disclosure.

### DETAILED DESCRIPTION

The present disclosure is generally related to replicating metadata. When a file located in a source file system is replicated to a target file system, the metadata associated with the file can be replicated as well. However, custom metadata that a user associates with the file may not be automatically replicated, as the custom metadata may be external to the file, and may reside in a database. One method to replicate the metadata is to manually run a script to export the metadata from the source file system's express query database, and import the metadata to the target file system's database, where it is associated with the path name of the replicated file. However, this method can be prone to errors. For example, a change in the path name of the replicated file can result in invalid association between the replicated file and the metadata.

Described herein is a method to automatically associate metadata with a replicated file in a target file system following file replication. An original file in a source file system can have its metadata associated with a unique identifier of the file. When the original file is replicated to a target file system, the metadata associated with the unique identifier of the file can be replicated as well. In the target file system, a unique identifier of the replicated file can be mapped to the unique identifier of the original file, such that the metadata is then associated with the unique identifier of the replicated file. In this way, the metadata replication and association can be performed automatically without user intervention. The metadata association can also be unaffected by changes or errors in the path name of the replicated file. Furthermore, the replicated metadata can be stored in a scalable pipelined database. The pipelined database may use a mechanism of lazy ingestion of file system events. The metadata associated with the replicated file may be stored in a query-able authority table in the pipelined database.

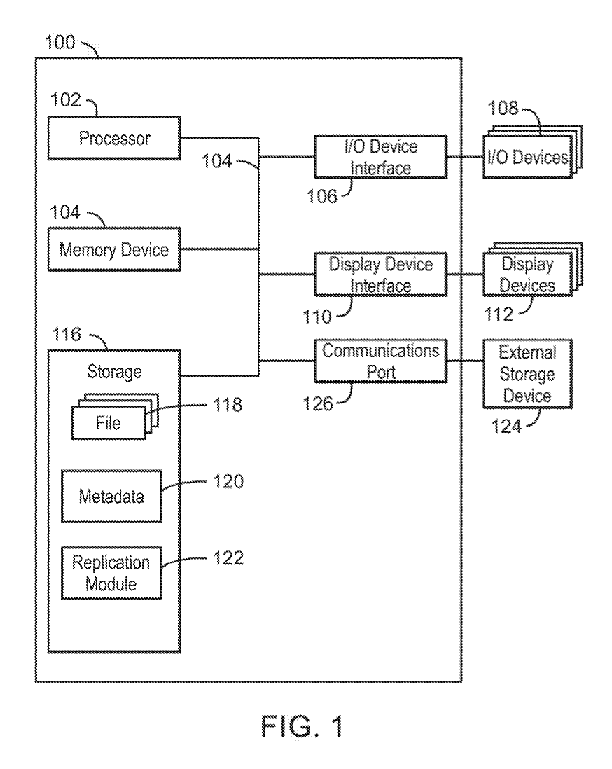

FIG. 1 is a block diagram of a computing system configured for replicating metadata, in accordance with examples of the present disclosure. The computing system 100 may include, for example, a server computer, a mobile phone, laptop computer, desktop computer, or tablet computer, among others. The computing system 100 may include a processor 102 that is adapted to execute stored instructions.

The processor 102 can be a single core processor, a multi-core processor, a computing cluster, or any number of other appropriate configurations.

The processor 102 may be connected through a system bus 104 (e.g., AMBA®, PCI®, PCI Express®, Hyper Transport®, Serial ATA, among others) to an input/output (I/O) device interface 106 adapted to connect the computing system 100 to one or more I/O devices 108. The I/O devices 108 may include, for example, a keyboard and a pointing device, wherein the pointing device may include a touchpad or a touchscreen, among others. The I/O devices 108 may be built-in components of the computing system 100, or may be devices that are externally connected to the computing system 100.

The processor 102 may also be linked through the system bus 104 to a display device interface 110 adapted to connect the computing system 100 to display devices 112. The display devices 112 may include a display screen that is a built-in component of the computing system 100. The display devices 112 may also include computer monitors, televisions, or projectors, among others, that are externally connected to the computing system 100.

The processor 102 may also be linked through the system bus 104 to a memory device 114. In some examples, the memory device 114 can include random access memory (e.g., SRAM, DRAM, eDRAM, EDO RAM, DDR RAM, RRAM®, PRAM, among others), read only memory (e.g., Mask ROM, EPROM, EEPROM, among others), non-volatile memory (PCM, STT_MRAM, ReRAM, Memristor), or any other suitable memory systems.

The processor 102 may also be linked through the system bus 104 to a storage device 116. The storage device 116 may contain one or more files 118 in a file system. The file 118 may be a document, application, media, or any other virtual item that can be stored. The storage device may also contain metadata 120, which provides information regarding the file 118. Such information may include time of file creation, ownership of the file, and file access permissions. In some examples, the metadata 120 may be custom metadata containing information that a user has manually associated with the file 118. A replication module 122 in the storage device can include instructions to direct the processor 102 to replicate the file 118 from a source location in the storage device 116 to a target location. The target location may be in a second storage device inside the computing system 100, or in an external device coupled to the computing system 100 via wired or wireless means. For example, an external storage device 124 may be linked to the system bus 104 via a communications port 126. The replication module 122 can also replicate the metadata 120 to the target location. The replication module 122 can map the replicated file to the original file 118, such that the replicated file is associated with the metadata.

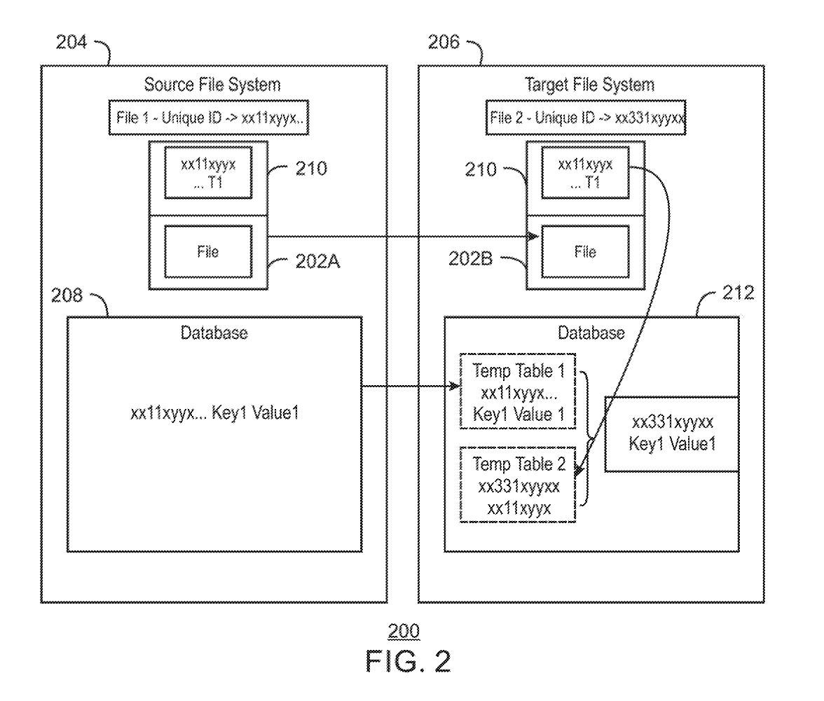

FIG. 2 is a block diagram illustrating metadata replication from a source file system to a target file system. The examples discussed herein can be performed by a computer containing a processor and at least one storage device. A first file 202a stored in a source file system 204 of the storage device can be replicated to produce an identical second file 202b stored in a target file system 206. The target file system 206 may be in a second storage device in the computer itself, an external storage device connected to the computer, or a server coupled to the computer in a network.

The first file 202a can include a unique identifier and associated with metadata. The metadata can contain at least one key and value pair. The key is the name of a metadata element, while the value pertains to the information contained in the metadata element. In one example, the metadata may be custom metadata describing a color of the first file 202a. The key of the custom metadata may read “color”, while the value of the custom metadata may read “red”. The unique identifier and the metadata can be stored in a first database 208 of the source file system 204. The unique identifier and metadata may be associated with one another and stored in a table of the first database 208. The first file 202a can also include an extended attribute 210, which contains the unique identifier and a timestamp of the metadata. The timestamp can refer to when the metadata was created or last modified.

The first file 202a can be replicated to produce the identical second file 202b to be stored in the target file system 206. The second file 202b can use a different unique identifier from the first file 202a. The extended attribute 210, which contains the unique identifier of the first file 202a and the timestamp of the metadata, can be replicated to the target file system 206 as well. Furthermore, the table in the first database 208 can also be replicated to a second database 212 in the target file system 206.

The unique identifier of the second file 202b can be mapped to the unique identifier of the first file 202a in a temporary table in the second database 212. As a result, the unique identifier of the second file 202b becomes associated with the metadata. Thus, the metadata can correspond to both the first file 202a and the second file 202b. The process of associating the second file 202b to the metadata can be done automatically in response to replication of the first file 202a. The second database 212 can be a pipelined database wherein the association between the metadata and the second file 202b can be stored in a query-able table.

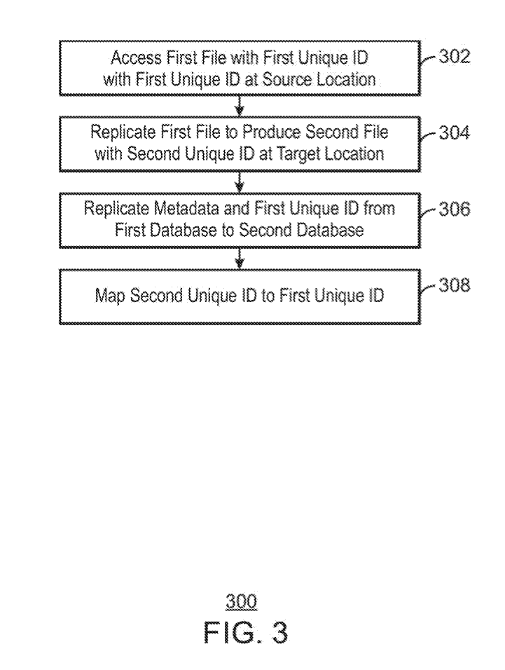

FIG. 3 is a process flow diagram of a method for replicating metadata, in accordance with examples of the present disclosure. The method 300 can be performed by a computing system 100 (as seen in FIG. 1) containing a processor and a storage device.

At block 302, the processor accesses a first file with a first unique identifier at a source location in a storage device. Metadata corresponding to the first file can be stored in a first database with the first unique identifier, such that the first unique identifier is associated with the metadata. The first file may include an extended attribute that contains the first unique identifier and a timestamp corresponding to the metadata.

At block 304, the processor replicates the first file to produce a second file at a target location. The target location may be in a second storage device, either contained in the computing system or coupled externally. The extended attribute of the first file can be replicated to the target location as well. The second file can have a second unique identifier.

At block 306, the processor replicates the metadata and the first unique identifier to a second database. The second database may be at the target location. The metadata and the first unique identifier may be associated together in a temporary table in the second database.

At block 308, the processor maps the second unique identifier to the first unique identifier in the second database. As a result, the second unique identifier is associated with the metadata corresponding to the first file.

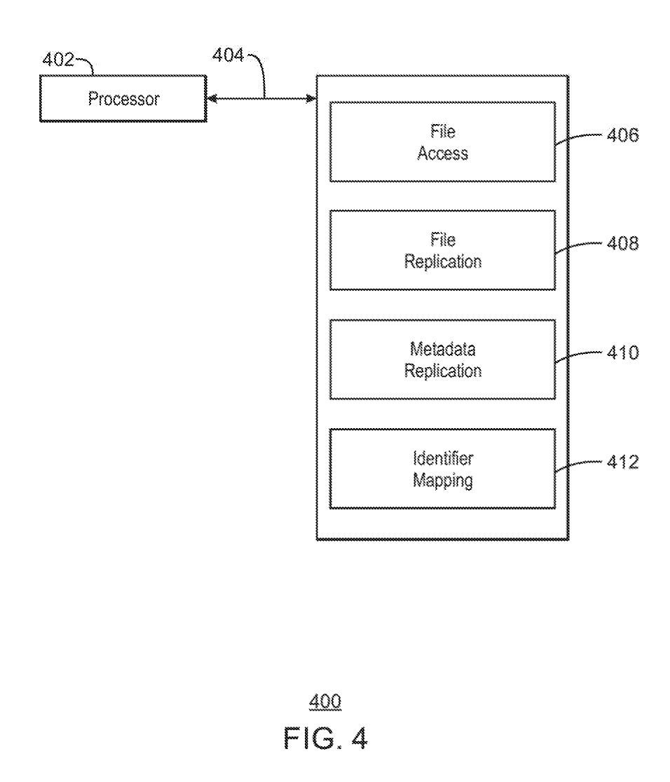

FIG. 4 is a block diagram of a tangible, non-transitory computer-readable medium containing instructions configured to direct a processor to replicate metadata, in accordance with examples of the present disclosure. The tangible, non-transitory computer-readable medium 400 can include RAM, a hard disk drive, an array of hard disk drives, an optical drive, an array of optical drives, a non-volatile memory, a universal serial bus (USB) drive, a digital versatile disk (DVD), or a compact disk (CD), among others. The tangible, non-transitory computer-readable media 400 may be accessed by a processor 402 over a computer bus 404. Furthermore, the tangible, non-transitory computer-readable medium 400 may include instructions configured to direct the processor 402 to perform the techniques described herein.

As shown in FIG. 4, the various components discussed herein can be stored on the non-transitory, computer-readable medium 400. A file access module 406 is configured to access a first file at a source location in a storage device, wherein metadata corresponding to the first file is stored in a first database with the first unique identifier. A file replication module 408 is configured to replicate the first file to produce a second file at a target location, wherein the second file has a second unique identifier. A metadata replication module 410 is configured to replicate the metadata and the first unique identifier to a second database. An identifier mapping module 412 is configured to map the second unique identifier to the first unique identifier in the second database.

The block diagram of FIG. 4 is not intended to indicate that the tangible, non-transitory computer-readable medium 400 are to include all of the components shown in FIG. 4. Further, the tangible, non-transitory computer-readable medium 400 may include any number of additional components not shown in FIG. 4, depending on the details of the specific implementation.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method, comprising:
accessing a first file with a first unique identifier at a source location in a storage device, wherein metadata corresponding to the first file is stored in a first database with the first unique identifier;
replicating the first file to produce a second file at a target location, the second file having a second unique identifier;
replicating the metadata and the first unique identifier to a second database; and
mapping the second unique identifier to the first unique identifier in the second database.

2. The method of claim 1, wherein the first file comprises an extended attribute that contains the first unique identifier.

3. The method of claim 2, comprising replicating the extended attribute of the first file to the target location.

4. The method of claim 1, wherein the second database is a pipelined database.

5. The method of claim 1, wherein the metadata comprises a key and a value.

6. A system, comprising:
a replication module to provide instructions that replicate a file with metadata from a source location to a target location;
a processor to execute the instructions provided by the replication module,
wherein the instructions direct the processor to:
access a first file with a first unique identifier at the source location in a storage device, wherein metadata corresponding to the first file is stored in a first database with the first unique identifier;
replicate the first file to produce a second file at the target location, the second file having a second unique identifier;
replicate the metadata and the first unique identifier to a second database; and
map the second unique identifier to the first unique identifier in the second database.

7. The system of claim 6, the first file comprising an extended attribute that contains the first unique identifier.

8. The system of claim 7, the processor to replicate the extended attribute of the first file to the target location.

9. The system of claim 7, wherein the second database is a pipelined database.

10. The system of claim 6, the metadata comprising a key and a value.

11. A tangible, non-transitory, computer-readable medium, comprising instructions configured to direct a processor to:
access a first file with a first unique identifier at a source location in a storage device, wherein metadata corresponding to the first file is stored in a first database with the first unique identifier;
replicate the first file to produce a second file at a target location, the second file having a second unique identifier;
replicate the metadata and the first unique identifier to a second database; and
map the second unique identifier to the first unique identifier in the second database.

12. The tangible, non-transitory, computer-readable medium of claim 11, the first file comprising an extended attribute that contains the first unique identifier.

13. The tangible, non-transitory, computer-readable medium of claim 12, comprising instructions configured to direct a processor to replicate the extended attribute of the first file to the target location.

14. The tangible, non-transitory, computer-readable medium of claim 12, wherein the second database is a pipelined database.

15. The tangible, non-transitory, computer-readable medium of claim 11, the metadata comprising a key and a value.
